(19) United States
(12) Patent Application Publication
(10) Pub. No.: US 2011/0262613 A1
(43) Pub. Date: Oct. 27, 2011

(54) NOVEL MANUFACTURING METHOD OF ABALONE-OYSTER SAUCE AND THE PRODUCT THEREOF

(76) Inventors: Yoon-Je CHO, Seoul (KR); Eun-Seol KIM, Seoul (KR); Hyun-Kyou SHIM, Seoul (KR); Areum CHOI, Gyeonggi-do (KR)

(21) Appl. No.: 13/085,866

(22) Filed: Apr. 13, 2011

(30) Foreign Application Priority Data
Apr. 22, 2010 (KR) 10-2010-0037553

(51) Int. Cl. A23L 1/39

(52) U.S. Cl. 426/589

(57) ABSTRACT

A method produces an abalone-oyster sauce prepared by mixing and processing abalone, oyster and tangle in a proper ratio and is for suitable for mass production and an abalone-oyster sauce obtains from an optimal compounding ratio of a composition to produce the most suitable flavor of abalone.

The present invention relates to a novel abalone-oyster sauce and a method for producing the same. More specifically, the present invention relates to a method for producing an abalone-oyster sauce to which an extract made of processed abalone, oyster and sea tangle is applied. For this purpose, such a novel abalone-oyster sauce is prepared by optimizing a compounding ratio of a composition to produce the most suitable taste and flavor of abalone. Further, the present invention relates to a method for mass production of an abalone-oyster sauce, which enables long-term distribution at room temperature by inhibiting microbial growth during storage of the abalone-oyster sauce.

### BACKGROUND ART

Sauce is a food material indispensable in the restaurant business and food preparation industry.

According to the Korean Food Code, a sauce is defined as a material which is prepared by adding spice, soybean seasoning paste, saccharides, common salt, vinegar and the like to an animal or vegetable raw material and is used for the purpose of enhancing the flavor of foods before or after cooking thereof. Sauce is widely used in various forms in Western-style foods as well as Korean-style and Chinese-style foods. Particularly, sauces based on seafood such as oysters have characteristic flavor and excellent consumer preference and therefore have been largely used in Chinese-style foods and are increasingly used in Korean-style foods as well.

As to prior arts relating to sauce developed using seafood as raw materials, Korean Patent No. 10-0473044 discloses a method for producing a functional seafood-like flavoring sauce from seafood waste; Korean Patent Application Laid-Open No. 2001-0081304 discloses a novel desalted and concentrated oyster or tuna product and a method for producing the same; Korean Patent Application Laid-Open No. 2009-0078134 discloses a method for producing a sea tangle-fruit sauce; and Korean Patent No. 10-0377541 discloses a method for producing an oyster sauce.

Other related prior arts disclose a method of processing a boiled extract of a sea product such as shellfish, oyster or cuttlefish, a method of applying a sea tangle powder to a sauce, a method of producing an oyster sauce, and the like. Particularly, oyster sauce products developed by adding other supplementary materials such as starch to an oyster extract or an oyster hydrolysate have been marketed and widely used for a long time. Although such sauce products are relatively expensive, application of seafood which is difficult to process, as a sauce, can bring about a great contribution to convenience of use and improvement in flavor of foods.

Meanwhile, among sea product raw materials, abalone has characteristic flavor, is rich in nutritive components and is therefore regarded as high-quality seafood, and has been used for medicinal purposes as well as for food. As the related prior arts of abalone, Korean Patent Application Laid-Open No. 2009-0096811 discloses a method of producing an abalone-seasoned hot pepper paste contained in a retort pouch; Korean Patent Application Laid-Open No. 2009-0062427 discloses a method for producing an abalone-seasoned soy sauce; Korean Patent Application Laid-Open No. 2009-0043961 discloses an abalone-seasoned soy sauce using Salicornia herbacea L. and a method for producing the same; and Korean Patent No. 10-0225201 discloses an abalone product and a method for producing the same.

However, most prior art relates to methods for producing a seasoning paste using processed abalone, rather than to sauces, that is, not to the production of a sauce using abalone as a raw material. Therefore, it can be seen that there is no disclosure of a method for producing a sauce using abalone as a main material.

### DISCLOSURE

### Technical Problem

Therefore, the present invention has been made in view of the above circumstances, and it is an object of the present invention to provide a method for producing an abalone-oyster sauce which uses abalone rich in nutritious components and having characteristic flavor as a main material, is in the form of a liquid sauce for convenient intake, and enables room temperature distribution and easy mass production.

A specific object of the present invention is to provide a novel abalone-oyster sauce which is prepared by optimizing a compounding ratio of abalone, oyster and sea tangle extracts to produce the most suitable taste and flavor of abalone.

Another object of the present invention is to provide a method for mass production of an abalone-oyster sauce, which enables room-temperature distribution by inhibiting microbial growth during room-temperature storage of the abalone-oyster sauce.

### Technical Solution

In accordance with an aspect of the present invention, the above and other objects can be accomplished by the provision and evaluation of an abalone-oyster sauce containing an abalone extract, an oyster extract, a sea tangle extract, an onion puree, mashed garlic, an onion seasoning oil, a garlic seasoning oil, sugar, refined salt, soy sauce, starch, citric acid and purified water.

In accordance with another aspect of the present invention, there is provided a method for mass production of an abalone-oyster sauce, which includes selecting, mixing and stirring food materials including an abalone extract, an oyster extract, a sea tangle extract, an onion puree, mashed garlic, an onion seasoning oil, a garlic seasoning oil, sugar, refined salt, soy sauce, starch, citric acid and purified water; heating the stirred mixture to a temperature of 65 to 80° C. to be gelatinized; homogenizing the gelatinized mixture; heat-sterilizing the homogenized mixture; and filling and packaging the heat-sterilized mixture.

### Advantageous Effects

The present invention has an excellent effect of providing an abalone-oyster sauce which enables not only convenient intake of abalone with characteristic flavor by optimizing taste and flavor of abalone, but also long-term distribution at room temperature for 12 months.

Hereinafter, the specific method of the present invention will be described in more detail with reference to the following Examples.

### MODE FOR INVENTION

The present invention is intended to provide an abalone-oyster sauce containing an abalone extract, an oyster extract, a sea tangle extract, an onion puree, mashed garlic, an onion seasoning oil, a garlic seasoning oil, sugar, refined salt, soy sauce, starch, citric acid and purified water.

For this purpose, the abalone extract is preferably added in an amount of 3 to 20 parts by weight based on 100 parts by weight of the abalone-oyster sauce. Here, the abalone extract used was prepared by mixing 50 parts by weight of abalone with an enzyme and purified water, followed by extraction, filtration and concentration.

The oyster extract is preferably added in an amount of 3 to 20 parts by weight based on 100 parts by weight of the abalone-oyster sauce.

The sea tangle extract is preferably added in an amount of 1 to 10 parts by weight based on 100 parts by weight of the abalone-oyster sauce.

The onion puree is preferably added in an amount of 3 to 5 parts by weight based on 100 parts by weight of the abalone-oyster sauce.

The mashed garlic is preferably added in an amount of 3 to 5 parts by weight based on 100 parts by weight of the abalone-oyster sauce.

The onion seasoning oil is preferably added in an amount of 0.3 to 3 parts by weight based on 100 parts by weight of the abalone-oyster sauce.

The garlic seasoning oil is preferably added in an amount of 0.3 to 3 parts by weight based on 100 parts by weight of the abalone-oyster sauce.

Based on 100 parts by weight of the abalone-oyster sauce in accordance with the present invention, the sugar is preferably added in an amount of 15 to 20 parts by weight, the refined salt is preferably added in an amount of 5 to 10 parts by weight, and the soy sauce is preferably added in an amount of 2 to 5 parts by weight.

The starch has an effect of preventing emulsification and separation of the abalone-oyster sauce in accordance with the present invention and is preferably added in an amount of 2 to 5 parts by weight based on 100 parts by weight of the abalone-oyster sauce.

The citric acid is preferably added in an amount of 0.1 to 0.5 parts by weight based on 100 parts by weight of the abalone-oyster sauce. In particular, citric acid among organic acids is most preferable to impart flavor to the final sauce and is useful to adjust pH to a value of less than 4.1.

Further, the present invention provides a method for mass production of an abalone-oyster sauce, which includes (a) stirring an abalone extract, an oyster extract, a sea tangle extract, an onion puree, mashed garlic, an onion seasoning oil, a garlic seasoning oil, sugar, refined salt, soy sauce, starch, citric acid and purified water; (b) heating the stirred mixture to a temperature of 65 to 80° C. to be gelatinized; (c) homogenizing the gelatinized mixture; (d) heat-sterilizing the homogenized mixture; and (e) filling and packaging the heat-sterilized mixture.

For this purpose, Step (a) includes adding the compositions to purified water, followed by high-speed stirring, and

Step (b) includes heating the stirred mixture to a temperature of 65 to 80° C., in order to assist gelatinization of starch in the stirred mixture and to facilitate sterilization of the mixture.

Step (c) includes homogenization of the mixture using a rotary homogenizer. Here, the homogenization is preferably carried out at 3000 rpm for 10 minutes.

Step (d) includes sterilization of the homogenized mixture in order to minimize microbial contamination. The sterilization is preferably carried out in a sauce tank at 85° C. for 30 minutes.

Step (e) includes filling and packaging the sterilized mixture, preferably in a glass bottle, followed by sealing.

Hereinafter, the present invention will be described in more detail with reference to specific embodiments, but the present invention is not limited thereto. It should be understood that all modified embodiments having slightly different effects by simple changes in constitutive components, and a compounding ratio and a compounding order thereof are also within the scope of the present invention.

### EXAMPLES

### Experimental Example 1

### Organoleptic Test of Abalone-Oyster Sauce with Varying Contents of Abalone Extract

For the purpose of optimizing characteristic flavor of abalone in the abalone-oyster sauce of the present invention, an abalone extract, an oyster extract, and a sea tangle extract were respectively prepared at varying contents. The sauces thus prepared were used in cooking, and quality attributes, such as general taste, preference for flavor of abalone, and palatability, were evaluated on a 5-point scale.

For carrying out the experiment, samples were prepared at varying contents of individual extract raw materials, as shown in Table 1 below. Sauces a, b and c respectively employed the corresponding extract(s), and Sauce d employed a heated mixture of an abalone extract, an oyster extract and a sea tangle extract.

TABLE 1
Content ratio of extract raw materials

| | Designation | Abalone | Oyster | Sea tangle |
|---|---|---|---|---|
| Raw material | of Sauce | extract | extract | extract |
| Content | a | 1~10 | — | — |
| | b | 1~10 | 1~10 | 1~10 |
| | c | 3~20 | 3~20 | 1~10 |
| | d | 3~20 | | |

An organoleptic test for inspecting quality of the sauces prepared according to varying contents of the extracts as given in Table 1 was carried out by 50 panel subjects. The sauces were respectively used in cooking, and quality attributes, such as general taste, preference for flavor of abalone, and palatability, were evaluated on a 5-point scale. The results are given in Table 2 below.

TABLE 2
Organoleptic test of abalone sauces prepared according
to varying contents of extract raw materials

| | |
|---|---|
| | Score according to contents |
| Evaluation | of extract raw materials |

| Attribute | item | a | b | c | d |
|---|---|---|---|---|---|
| Quality | General | 3.3 | 3.4 | 3.8 | 3.9 |
| attributes | taste | | | | |
| | Preference | 3.2 | 3.4 | 4.0 | 4.0 |
| | for flavor of | | | | |
| | abalone | | | | |
| | Palatability | 3.1 | 3.3 | 3.7 | 3.8 |

Note:
Scale of scores; 5: very good, 4: good, 3: moderate, 2: poor, 1: very poor

As can be seen from the results of Table 2 above, as compared to when the sauce is prepared using an abalone extract alone, the sauces prepared using an abalone extract in combination with an oyster extract and a sea tangle extract were superior in general quality attributes. To this end, the present inventors have confirmed that it is preferable to prepare an abalone-oyster sauce by controlling the compounding ratio of an abalone extract, an oyster extract and a sea tangle extract, that is, by mixing 3 to 20 parts by weight of an abalone extract, 3 to 20 parts by weight of an oyster extract, 1 to 10 parts by weight of a sea tangle extract, 3 to 5 parts by weight of an onion puree, 3 to 5 parts by weight of mashed garlic, 0.3 to 3 parts by weight of an onion seasoning oil, 0.3 to 3 parts by weight of a garlic seasoning oil, 15 to 20 parts by weight of sugar, 5 to 10 parts by weight of refined salt, 2 to 5 parts by weight of soy sauce, 2 to 5 parts by weight of starch, and 0.1 to 0.5 parts by weight of citric acid with the balance being purified water.

### Experimental Example 2

### Standard Requirements of Sauces and Microbial Analysis According to Various Sterilization Conditions

Raw materials such as concentrates prepared at various content ratios of the above-mentioned extracts in accordance with the present invention were added to purified water, followed by mixing of powders under high-speed stirring. The sauce composition was heated to 80° C., in order to assist gelatinization of starch and to facilitate sterilization of the composition. After reaching 80° C., homogenization was carried out.

In order to determine the homogenization conditions, the composition was stored after being homogenized for 10 minutes at various rotational speeds of 1000 rpm, 2000 rpm and 3,000 rpm, respectively. The experimental group subjected to homogenization at a rotational speed of 3000 rpm was stable even after 6-month storage at room temperature, whereas the experimental group subjected to homogenization at a rotational speed of 1000 rpm or 2000 rpm exhibited separation of the supernatant before reaching 6 months. Therefore, the homogenization conditions were determined such that the composition was homogenized in a rotary homogenizer at 3000 rpm for 10 minutes.

After homogenization was completed, sterilization was carried out in order to minimize microbial contamination. The mixture was sterilized at 85° C. for 30 minutes (sterilization in a sauce tank), or at 110° C. for 15 seconds (HTST), or at 120° C. for 10 seconds (UHT), respectively, and sterilizing effects were compared therebetween.

Each of the sterilized compositions was placed in a container, followed by sealing and water cooling. The pH, salinity and sugar content of the cooled compositions were analyzed. Analysis results are given in Table 3 below. The sterilization conditions were identical for all of the individual compositions, and the compositions exhibited no growth of microorganisms under all of the sterilization conditions.

TABLE 3
Standard requirements of sauces and microbial analysis
results according to various sterilization conditions

| | | | | Microbial | |
|---|---|---|---|---|---|
| | | | | count | Microbial |
| | | | | (immediately | count |
| Sterilization | | | Sugar | after | (after 12 |
| conditions | pH | Salinity | content | preparation) | months) |
| 85° C., 30 | 4.0~4.3 | 10.8~11.2 | 42.0~43.0 | Less than | Less than |
| min | | | | 10 | 10 |
| 110° C., 15 | 4.0~4.3 | 10.8~11.2 | 42.0~43.0 | Less than | Less than |
| sec | | | | 10 | 10 |
| 120° C. 10 | 4.0~4.3 | 10.8~11.2 | 42.0~43.0 | Less than | Less than |
| sec | | | | 10 | 10 |

### Example 1

### Preparation of Inventive Abalone-Oyster Sauce (100 Parts by Weight)

Step 1: 15 parts by weight of an abalone-oyster extract, 2 parts by weight of an onion puree, 2 parts by weight of mashed garlic, 1 part by weight of an onion seasoning oil, 1 part by weight of a garlic seasoning oil, and 3 parts by weight of soy sauce were weighed and mixed.

Step 2: 15 parts by weight of sugar, 5 parts by weight of refined salt, 3 parts by weight of starch, and 1 part by weight of citric acid, which are powdered raw materials, were weighed and mixed.

Step 3: The raw materials of Step 2 were introduced to the stirred liquid raw materials of Step 1. The balance of purified water was added thereto. The mixture was warmed to 80° C. with stirring to achieve gelatinization of starch for 10 minutes.

Step 4: The solution of Step 3 was homogenized at 3000 rpm for 10 minutes, followed by sterilization at 110° C. for 15 seconds.

Step 5: The sterilized solution was filled in an airtight glass container, followed by sealing and cooling.

### Example 2

### Organoleptic Test of the Prepared Abalone-Oyster Sauce

An organoleptic test for inspecting the quality of the abalone-oyster sauce prepared according to the present invention was carried out by 150 housewives whose ages were in the range of 25 to 49. The housewives used the sauce more than two times in cooking and evaluated quality attributes, such as general taste, preference for color tone, preference for concentration, preference for salty taste, and palatability on a 5-point scale. The sauce was applied to easy-making foods at home such as fried rice, and fried sea products. The results are given in Table 4 below.

TABLE 4
Results of quality evaluation when the inventive
abalone-oyster sauce is applied to cooking

| Attribute | Evaluation item | Scores |
|---|---|---|
| Quality attributes | General taste | 3.9 |
| | Preference for color tone | 3.9 |
| | Preference for | 3.4 |
| | concentration | |
| | Preference for flavor | 3.9 |
| | Preference for salty taste | 3.7 |
| | Palatability | 4.0 |

Note:
Scale of scores; 5: very good, 4: good, 3: moderate, 2: poor, 1: very poor

As can be seen from the results of Table 4 above, it was demonstrated that most of the housewives were generally satisfied with the abalone-oyster sauce product of the present invention.

### Example 3

### Comparative Evaluation and Analysis Between the Abalone-Oyster Sauce Prepared According to the Present Invention and Commercially Available Oyster Sauces

An organoleptic test for comparative analysis of qualities between the abalone-oyster sauce prepared according to the present invention and commercially available oyster sauce products (a to e) was carried out by 200 housewives with age in the ranges of 25 to 49, who had usually used commercially available oyster sauces. The housewives used the individual sauces more than two times in cooking and evaluated general satisfaction levels based on comparison with conventionally used commercially available oyster sauces. The results are given in Table 5 below.

TABLE 5
Results of quality evaluation when the abalone-oyster sauce of the present
invention is applied to cooking by users of commercially available oyster sauces

| | | Commercially available oyster sauces | | | | |
|---|---|---|---|---|---|---|
| Attribute | Evaluation | a | b | c | d | e |
| Quality | General taste | 4.1 | 4.3 | 4.0 | 4.2 | 4.3 |
| attributes | when | | | | | |
| | compared | | | | | |
| | with | | | | | |
| | conventional | | | | | |
| | oyster sauces | | | | | |

| | |
|---|---|
| Average | 4.2 |

Note:
Scale of scores;
5: very good,
4: good,
3: moderate,
2: poor,
1: very poor

As can be seen from the results of Table 5 above, it was confirmed that most of the housewives who had usually used commercially available oyster sauces were greatly satisfied with the use of the abalone-oyster sauce product of the present invention.

Meanwhile, the term “abalone-oyster extract” as used herein is defined as an extract containing 3 to 20 parts by weight of an abalone extract, 3 to 20 parts by weight of an oyster extract, and 1 to 10 parts by weight of a sea tangle extract, based on 100 parts by weight of the abalone-oyster sauce of the present invention, together with the sauce raw materials mentioned in Example 1. In the method for mass production of an abalone-oyster sauce product in accordance with the present invention, the abalone-oyster sauce product of the present invention may be produced by preparing a composition of the above-mentioned three raw material extracts mixed in advance in the above-mentioned compounding ratio and using 3 to 20 parts by weight of the composition.

### INDUSTRIAL APPLICABILITY

As apparent from the above description, the present invention has an excellent effect of providing a novel abalone-oyster sauce having characteristic flavor and excellent organoleptic effects through the application of raw material extracts of marine life including abalone, oyster, sea tangle extracts, etc. Therefore, the present invention is very useful in seafood processing industries and cooking industries.

1. An abalone-oyster sauce comprising an abalone extract, an oyster extract, a sea tangle extract, an onion puree, mashed garlic, an onion seasoning oil, a garlic seasoning oil, sugar, refined salt, soy sauce, starch, citric acid and purified water.

2. An abalone-oyster sauce comprising, based on 100 parts by weight of the abalone-oyster sauce, 3 to 20 parts by weight of an abalone-oyster extract composition containing a mixture of 3 to 20 parts by weight of an abalone extract, 3 to 20 parts by weight of an oyster extract and 1 to 10 parts by weight of a sea tangle extract.

3. An abalone-oyster sauce comprising, based on 100 parts by weight of the abalone-oyster sauce, 3 to 20 parts by weight of an abalone extract, 3 to 20 parts by weight of an oyster extract, 1 to 10 parts by weight of a sea tangle extract, 3 to 5 parts by weight of an onion puree, 3 to 5 parts by weight of mashed garlic, 0.3 to 3 parts by weight of an onion seasoning oil, 0.3 to 3 parts by weight of a garlic seasoning oil, 15 to 20 parts by weight of sugar, 5 to 10 parts by weight of refined salt, 2 to 5 parts by weight of soy sauce, 2 to 5 parts by weight of starch, and 0.1 to 0.5 parts by weight of citric acid with the balance being purified water.

4. A method for producing an abalone-oyster sauce, comprising steps of:
(a) mixing and stirring an abalone extract, an oyster extract, a sea tangle extract, an onion puree, mashed garlic, an onion seasoning oil, a garlic seasoning oil, sugar, refined salt, soy sauce, starch, citric acid and purified water;
(b) heating the stirred mixture to be gelatinized;
(c) homogenizing the gelatinized mixture;
(d) heat-sterilizing the homogenized mixture; and
(e) filling and packaging the heat-sterilized mixture.

5. The method according to claim 4, wherein the step of mixing and stirring the extract raw material composition comprises, based on 100 parts by weight of the abalone-oyster sauce, 3 to 20 parts by weight of an abalone extract, 3 to 20 parts by weight of an oyster extract, 1 to 10 parts by weight of a sea tangle extract, 3 to 5 parts by weight of an onion puree, 3 to 5 parts by weight of mashed garlic, 0.3 to 3 parts by weight of an onion seasoning oil, 0.3 to 3 parts by weight of a garlic seasoning oil, 15 to 20 parts by weight of sugar, 5 to 10 parts by weight of refined salt, 2 to 5 parts by weight of soy sauce, 2 to 5 parts by weight of starch, and 0.1 to 0.5 parts by weight of citric acid with the balance being purified water.

6. The method according to claim 4, wherein the step of homogenizing the gelatinized mixture is carried out using a rotary homogenizer at 3000 rpm for 10 minutes.
